(19) United States
(12) Patent Application Publication
(10) Pub. No.: US 2007/0135200 A1
(43) Pub. Date: Jun. 14, 2007

(54) Betting race game

(76) Inventor: Yi Chen, Los Angeles, CA (US)

Correspondence Address: Yi Chen, 3436 Holyoke Drive, Los Angeles, CA, 90065-2740, US

(21) Appl. No.: 11/299,132

(22) Filed: Dec. 12, 2005

(51) Int. Cl. A63F 13/00

(52) U.S. Cl. 463/16; 463/6; 463/28

(57) ABSTRACT

A method to play a race game determined by multiple rounds of random numbers. The game allows any player anytime to start an individual race For each racer (12) on the race course (10) there is one variable finish line (11) to be selected by the player. Racers advance according to random numbers. Bets can be placed between any two rounds of random numbers. The holder of a hanging multi-race ticket earns credit to place free make-up bets. The winning probability of every bet and the calculation of payout and credit will be provided. An automatic computer/video version of the game is included.

### CROSS REFERENCE TO RELATED APPLICATIONS

This application is related to the application Ser. No. 691,944, filed on Aug. 5, 1996, now U.S. Pat. No. 5,795,226, granted on Aug. 18, 1998. The inventor's name was misprinted as Chen Yi. A certificate of correction was issued on Nov. 24, 1998.

### FIELD OF INVENTION

This invention relates to games of chance, more specifically, to methods of playing a betting race game determined by multiple rounds of random numbers.

### BACKGROUND OF THE INVENTION

About the time of U.S. Pat. No. 5,795,226 being granted, I started to ask myself, how I would like to market my patented games. For the automatic version, I set up a 3½ diskette entitled “NINE DICE”—which became U.S. registered trademark U.S. Pat. No. 2,322,258 on Feb. 22, 2000—. But it is only a PC game, not yet what I desire to make available at casinos simply because of using invisible computer random numbers. Nine Dice at casinos should be equipped with a visible mechanical random number generator. I have figured out a few such devices and keep on testing prototypes. The non-automatic version requires a 8′ by 8′ table, a rolling dice box, and so on, all made-to-order only. Its operation requires several workers. All this means high cost which will result in high house edge, something I hate. So, why not replace the big table by a monitor display? Why not let a keno bowl of balls to generate random numbers? Why not allow the players to determine the track length, and to start a race anytime? Why not drop the racing characteristic and bet on movers moving to certain sites? Besides, if a bet is to be determined by more than one round of random numbers and players are allowed to place make-up bets between two rounds, why not allow the hanging ticket holder to earn credit placing free make-up bets. Placing free bets reduces the payout of an original bet, but eliminates bettor's worry about bankroll and saves fund transaction handling. Answering these questions has resulted in filing this patent application and another one, both to be deposited with the U.S. Postal Service on the same day.

As far as playing surface is concerned every race game is prior art. As far as betting is concerned, all games of chance, such as keno, lottery, roulette, bingo are prior art. As far as technology is concerned any game requiring computer data processing is prior art. However, all games in a sense of prior art and known to the public don't have the following features offered in the present invention: Any player can start a race anytime. For each race the player selects own preferred finish lines for racers. The race will be determined by multiple rounds of random numbers. But the game operator generates random numbers, round by round, without concern in the progress of any race. The player places bets before the start and between any two rounds of random numbers. Besides make-up bets on a started race, the player can place multi-race bets —Pick 3, Pick 6 etc. at racetracks are of course multi-race bets.—and receive credit for a hanging ticket.

From 1976 to present there are 121, 611, 184, 293, 81 and 528 U.S. patents granted related to Classes 463/6, 463/16, 463/22, 273/243, 273/246 and 273/274 respectively. Some of them have been mentioned in U.S. Pat. No. 5,795,226. A few others will be listed in the Information Disclosure Statement.

### OBJECTS AND ADVANTAGES

The initial object is to improve my game presented in U.S. Pat. No. 5,795,226 to more varieties and less operation cost. The game can now be carried out by easily made to order equipments or existing keno/lottery facilities with minor changes. Its operator can set really low house edges for players intending to have fun rather than to win big money.

It is an object to provide a method allowing any individual player to start a race anytime, while the game operator simply to produce random numbers for the advancements of racers of all races.

It is an object to provide a race game with variable track length to be determined by each individual player.

Mutuel handles at racetracks show that nowadays people place more exotic pick 3 or trifecta bets than traditional Win/Place/Show. Imagine that a horse player likes 11 horses entered in three races with morning line odds from 8/5 to 6, and purchases a $2 4-4-3 pick 3 ticket costing $96. Assume that the first two races result in winners among the 4-4 selections. Knowing that the Will-pays of last 3 selections range from $250 to $380, the player spends $104 make-up Win bets to cover horses not included in the hanging ticket, in order to get paid no matter which horse wins race 3. According to the odds board at that time the payouts will be from $170 to $400, Thus, the 3-race fun with $200 bet may end up with $30 loss or up to $200 win. In this way of wagering, better players do beat others. But no matter how skillful plus insider information, the high operation cost, 20% average take-out makes any horse player ultimately a helpless overall loser. The invention is to open a new gaming domain where now every hanging ticket can always bring in a sure winner, without additional money out of pocket.

Fair gambling is to supply excitement and entertainment, while winning is always a matter of luck, and everybody in the long term will get beaten by the house edge or pari-mutuel take-out. Gambling loss is thus a price of fun. Here is a game of multiple choices and chances, allowing big money win with high negative expectation as well as much fun, small money win with minimal negative expectation. Besides, the holder of a hanging ticket can give up a part of potential huge win in exchange for up-to 100% sure small win on make-up choices. This can be repeated. All in all, more fun for people of our computer age.

### SUMMARY

The invention provides a betting game with a race course as playing surface. The race course shown on a bet slip requires a player to select one finish line for each of nine racers. Wagering machines in connection to a computer similar to those available at a racetrack will be required to examine bet slips, print bet tickets, store and process wagering and racing data.

The game requires a random number generator such as nine keno bowls—one bowl per racer—, each containing, equally many, four or five copies of balls numbered 1 to 6. An operator in charge will use it to produce nine random numbers from 1 to 6 per round, and display them on monitors, and input into the computer. The computer and each player advances racers according to the corresponding random numbers till three racers have reached their individual finish lines. The operator pays no attention to any advancements of racers, but simply produces another round of random numbers after a regulated period of time. Bets will be accepted during every break of random number generation.

A multi-race bet ticket becomes or remains hanging if it contains a winning bet in the last race and thus has a chance to be a winner at the end. The game provides the option that the holder of a hanging ticket receives credit to place free make-up bets, which will be henceforth referred to as credit bets.

Probability formulae as well as how to calculate payouts and credits will be provided.

The invention also includes an automatic video/computer version of the game.

### DRAWINGS

FIG. 1 is a flowchart illustrating the game process.

FIG. 2 is a Win/Place/Show bet slip.

FIG. 2A is a 3-Race Win/Place/Show bet ticket.

FIG. 2B is a Race 2 revised 3-Race Win/Place/Show bet ticket.

FIG. 2C is a Race 3 revised 3-Race Win/Place/Show bet ticket.

FIG. 3 is a Win/Exacta/Tricta bet slip.

FIG. 3A is a 3-Race Win/Exacta/Tricta bet ticket.

FIG. 3B is a Race 2 revised 3-Race Win/Exacta/Tricta bet ticket.

FIG. 3C is a Race 3 revised 3-Race Win/Exacta/Tricta bet ticket.

FIG. 4 shows a display of random numbers

FIG. 5 shows a betting activity statement.

FIG. 6 shows a Win/Place/Show probability table.

FIG. 7 is a Win-Win probability table.

FIG. 8 is an Exacta probability table.

FIGS. 9A and 9B are two parts of a Tricta probability table.

### DESCRIPTION OF THE PREFERRED PLAYING SURFACE AND THE RACE

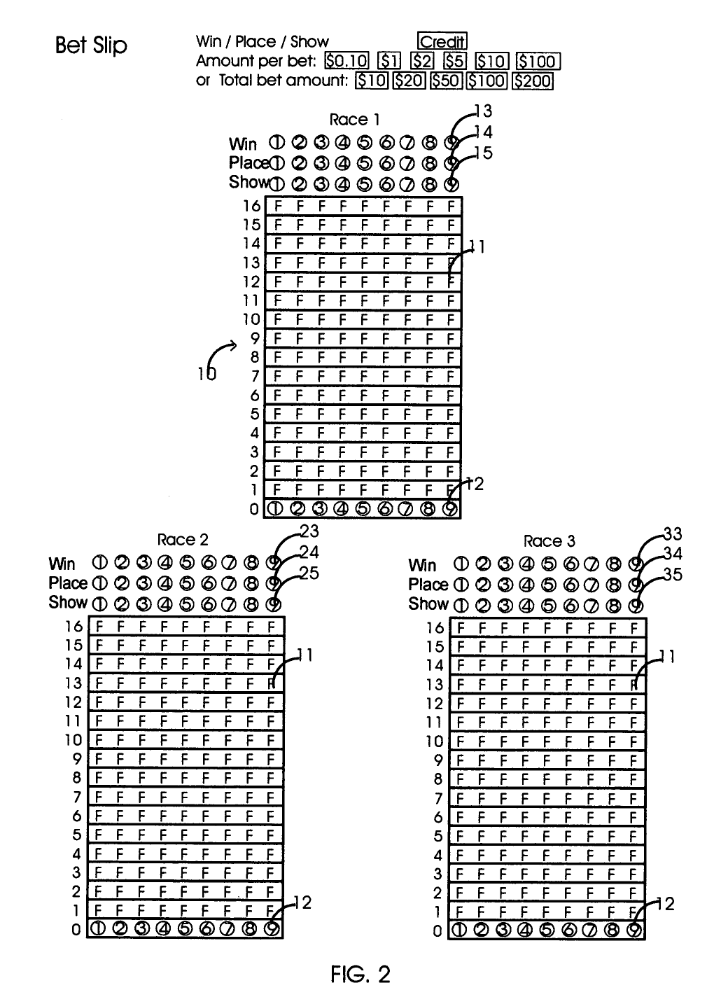

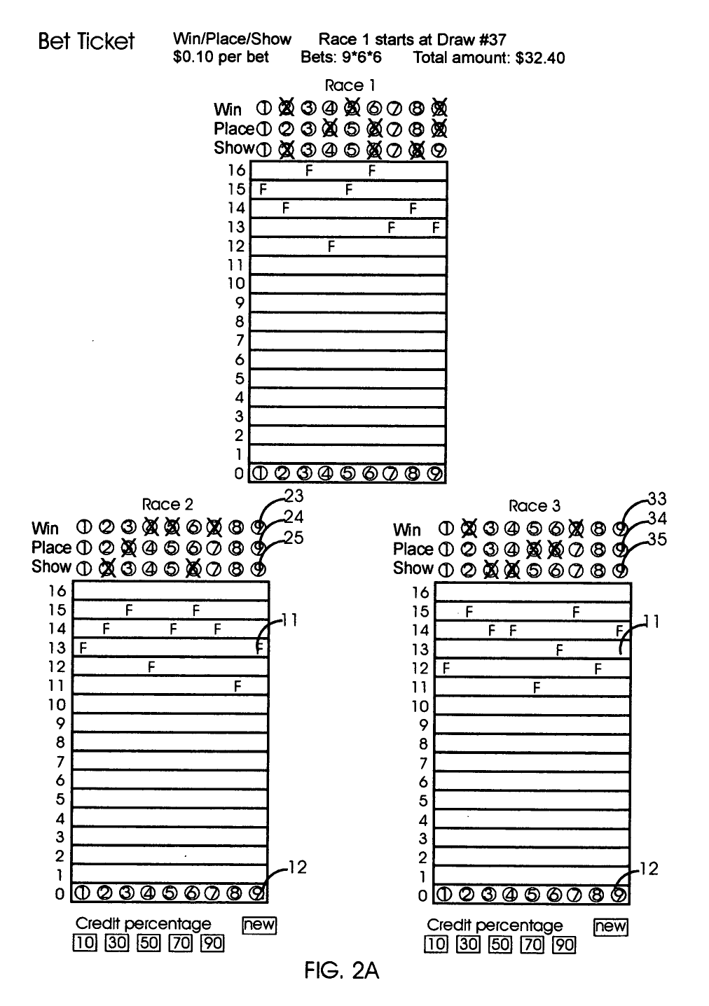

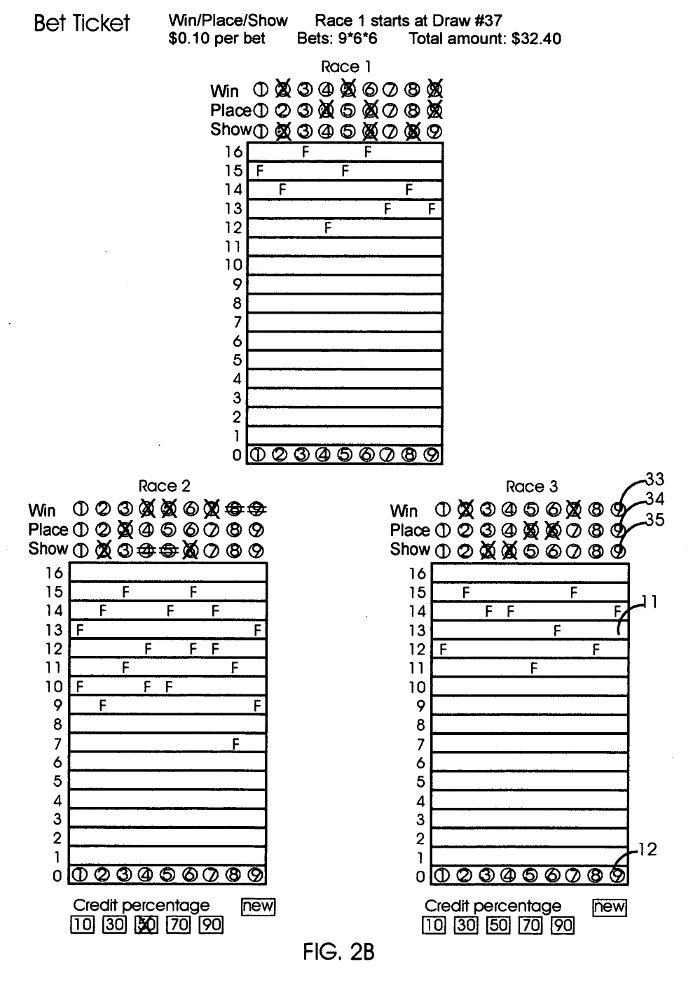

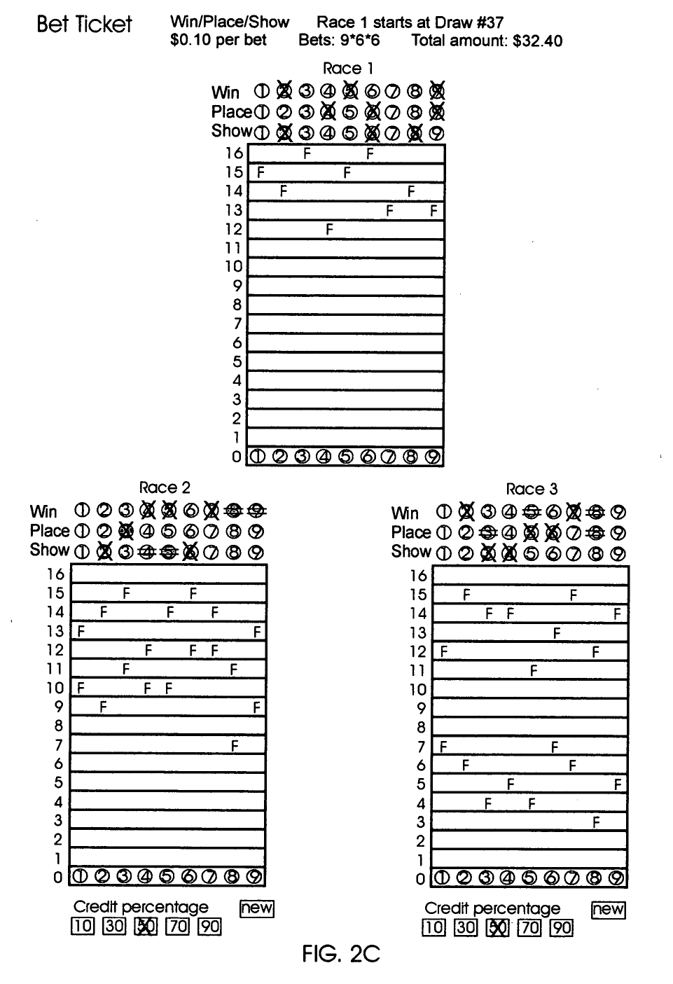

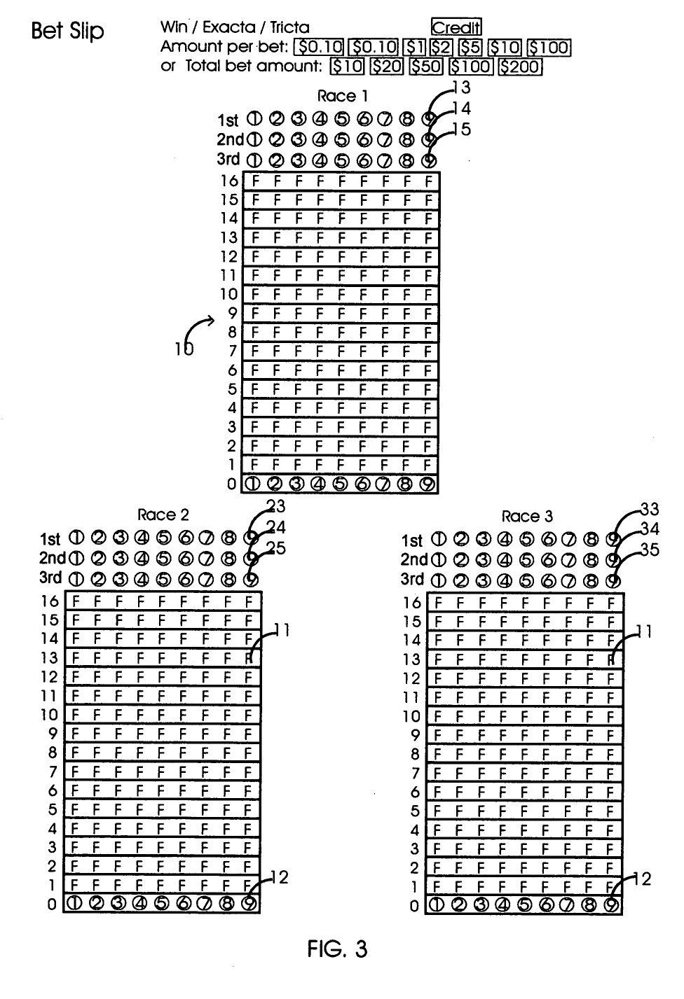

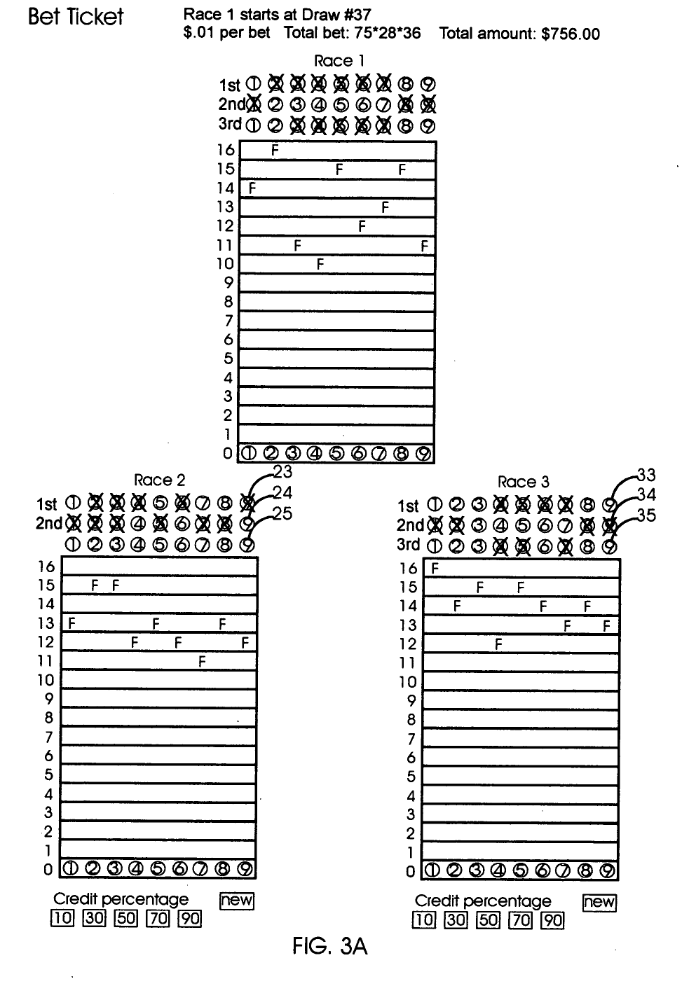

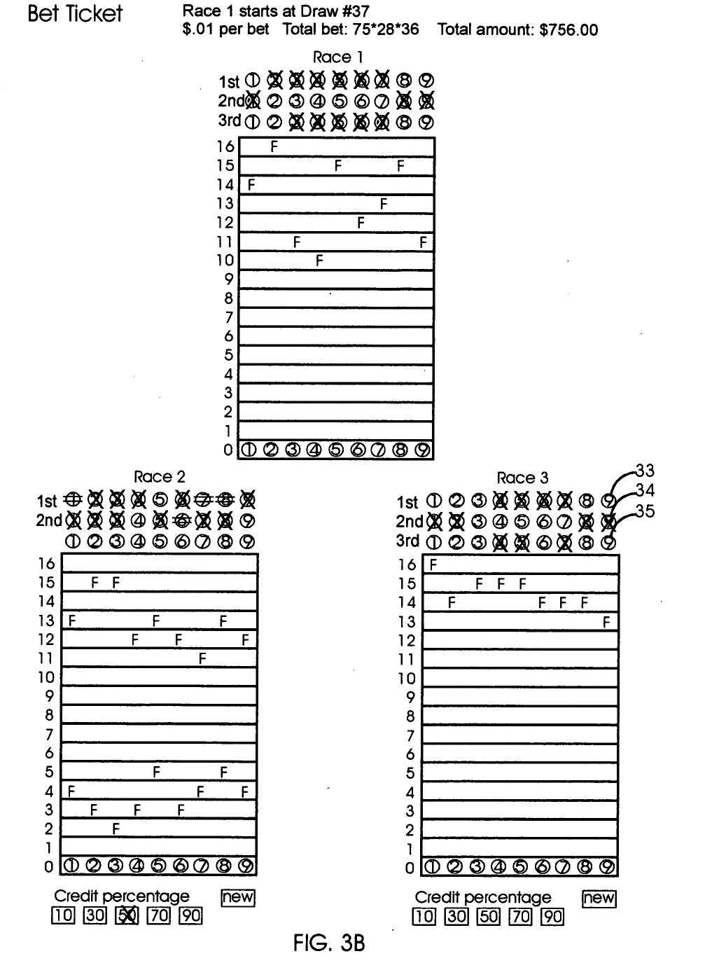

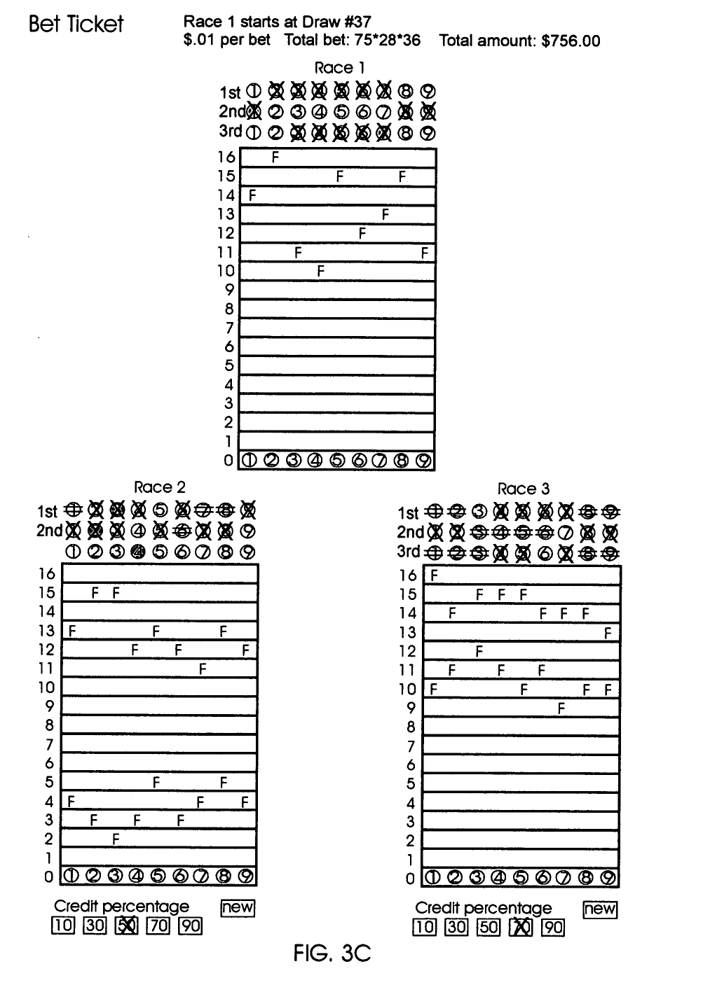

As shown in FIGS. 2 and 3, the invention provides a race course 10 as playing surface, on which there are nine racers 12, all shown on every bet slip. The race course contains seventeen numbered strips 11 called lines. Line 0 is where all racers are located. Each line except lines 0 contains one spot F lying straight in front of every racer. All and only those F lying straight ahead of a racer form the racetrack for that racer to advance. The player marks to select one F for each racer as finish spot/line. After a round of nine random numbers being generated, racers will advance one after another, staring from racer 1, as many spots as random numbers indicating. The race ends when three racers have reached selected finish lines. Since a racer's advancement is equivalent to the retreat of its finish line, to record a race, it's practical, to keep all racers in line 0, and reset their finish lines based on advancements.

### DESCRIPTION OF PLACING BETS

There are one- or multi-race Win/Place/Show bets using a bet slip as shown in FIG. 2. There are one- or multi-race Win/Exacta/Tricta bets using a bet slip as shown in FIG. 3. Besides the above regular bets there are credit bets using a hanging bet ticket, with or without a new bet slip.

On every bet slip, for every race to play, the player must mark to select one F in a line 11 as finish line/spot for every racer. Another common action is naturally to mark one ‘amount per bet’ except in the case of credit bet where ‘credit’ must be marked. All bets on a slip have the same per bet amount. Besides, placing credit bets, the bettor must select a credit percentage. This selected credit will be transferred to a new bet slip if which is required.

The end of Race 1 will cause the next draw to start Race 2. Every hanging multi-race ticket can be used as bet slip to place credit bets. It can be done any time before a racer in Race 2 reaches finish line. The end of Race 2 will cause the next draw to start Race 3. Every hanging or remaining hanging 3-race ticket can be used as bet slip to place credit bets. It can be done any time before a racer in Race 3 reaches finish line. The bettor may place Race 3 credit bets with or without placing Race 2 credit bets.

A complete 2-race bet contains two parts, one for selection(s) in Race 1, called Race 1 bet, and one for selection(s) in Race 2, called Race 2 bet. A complete 3-race bet contains three parts, one for selection(s) in Race 1, called Race 1 bet, another for selection(s) in Race 2, called Race 2 bet, and a third for selection(s) in Race 3, called Race 3 bet. Since it's always quite obvious if we are referring to a complete bet or a part, the term ‘complete’ will be omitted in the following,

A Win bet in a race becomes a winner if the selected racer finishes first. A Place bet in a race becomes a winner if the selected racer finishes first or second. A Show bet in a race becomes a winner if the selected racer finishes first, second or third. An Exacta bet in a race becomes a winner if both selected racers finish first and second as in selected order. A Tricta bet in a race becomes a winner if all three selected racers finish first, second, and third as in selected order. A multi-race bet wins if it contains a winner in each concerning race.

To place 1-race Win/Place/Show bets: The bettor marks to select one or several spots 13, 14, and/or 15. Each selection counts one bet. A Win bet on racer i is a 13(i) bet. A Place bet on racer j is a 14(j) bet. A Show bet on racer k is a 15(k) bet. Let #13(i), #14(j) and #15(k) denote respectively the number of 13(i), 14(j) and 15(k) selections. There are #Race1=#13(i)+#14(j)+#15(k) bets, which can bring in at moxt six winners.

To place 2-race Win/Place/Show bets: The bettor does first just as placing 1-race bets; then marks to select one or several spots 23, 24, and/or 25. Every selection extends all bets placed in Race 1. If the bettor wants only specific bets on racers i, j, k to be extended in specific ways instead of all possible, then it is necessary to use separate slips. Selected i′ in spot 23 will form Win-Win 13(i)23(i′) bets, Place-Win 4(j)23(i′) bets, and/or Show-Win 5(k)23(i′) bets. Selected racer j′ in spot 24 will form Win-Place 13(i)24(j′) bets, Place-Place 14(j)24(j′) bets, and/or Show-Place 15(k)24(j′) bets. Selected racer k′ in spot 25 will form Win-Show 13(i)25(k′) bets, Place-Show 14(j)25(k′) bets, and/or Show-Show 15(k)25(k′) bets. Let #23(i′), #24(j′) and #25(k′) denote respectively the number of 23(i′), 24(j′) and 25(k′) selections. Let #Race2=#23(i′)+#24(j′)+#25(k′). There are #Race1*#Race2 bets, which can bring in at moxt 36 winners.

To place 3-race Win/Place/Show bets: The bettor does first just as placing 2-race bets; then marks to select one or several spots 33, 34, and/or 35. Every selection extends all bets placed in Races 1 and 2. If the bettor wants only specific bets on racers i, j, k, i′, j′, k′ to be extended in specific ways instead of all possible, then it is necessary to use separate slips. Selected racer i″ in spot 33 will form Win-Win-Win 13(i)23(i′)33(i″) bets, Place-Win-Win 14(j)23(i′)33(i″) bets, Show-Win-Win 15(k)23(i′)33(i″) bets, Win-Place-Win 13(i)24(j′)33(i″) bets, Place-Place-Win 14(j)24(j′)33(i″) bets, Show-Place-Win 15(k)24(j′)33(i″) bets, Win-Show-Win 13(i)25(k′)33(i″) bets, Place-Show-Win 14(j)25(k′)33(i″) bets, Show-Show-Win 15(k)25(k′)33(i″) bets. Selected racer j″ in spot 34 will form Win-Win-Place 13(i)23(i′)34(j″) bets, Place-Win-Place 14(j)23(i′) 34(j″) bets, Show-Win-Place 15(k)23(i′)34(j″) bets, Win-Place-Place 13(i)24(j′)34(j′) bets, Place-Place-Place 14(j)24(j′)34(j″) bets, Show-Place-Place 15(k)24(j′)34(j″) bets, Win-Show-Place 13(i) 25(k′)34(j″) bets, Place-Show-Place 14(j)25(k′)34(j″) bets, Show-Show-Place 15(k)25(k′)34(j″) bets. Show-Win-Show 15(k)23(i′)35(k″) bets, Win-Place-Show 13(i)24(j′)35(k″) bets, Place-Place-Show 14(j)24(j′)35(k″) bets, Show-Place-Show 15(k)24(j′)35(k″) bets, Win-Show-Show 13(i)25(k′)35(k″) bets, Place-Show-Show 14(j)25(k′)35(k″) bets, Show-Show-Show 15(k)25(k′) 35(k″) bets. Let #33(i″), #34(j″) and #35(k″) denote respectively the number of 33(i″), 34(j″) an 35(k′) selections. Let #Race3=#33(i″)+#34(j″)+#35(k″). There are #Race1*#Race2*#Race3 bets, which can bring in at moxt 216 winners.

To place 1-race Win/Exacta/Tricta bets, the bettor marks to select one or several spots 13, 14, and/or 15. If one spot 15 is selected, then at least one spot 14 must be selected. If one spot 14 is selected, then at least one 13 must be selected. If there are only spot 13 being selected, then all bets are Win bets. If there are only spots 13 and 14 being selected, then all bets are Exacte bets. If there are spots 13, 14 and 15 being selected, then all bets are Tricta bets. In the case of Win bets, every selected racer i in spot 13 counts a bet. It is a 13(i) bet, which wins if racer i finishes first. In the case of Exacta bets, every selected racer i in spot 13 and every selected racer j in spot 14 with i≠j will be combined to form a 13(i)14(j) bet, which wins if racer i finishes first and racer j finishes second. If the bettor wants only specific combinations of selected spots 13 with 14 instead of all possible, then it is necessary to use separate slips.—For example, using one bet slip, you can bet racers 1 or 2 finishing first and racers 3 or 4 finishing second, This is four bets. If you want to bet EITHER racer 1 finishing first and racer 3 finishing second OR racer 3 finishing first and racer 4 finishing second. This is two bets; and you need to use two bet slips to place them separately. —In the case of Tricta bets, every selected racer i in spot 13 and every selected racer j in spot 14 and every selected racer k in spot 15 with i≠j≠k≠i will be combined to form a 13(i)14(j)15(k) bet. All bets on a slip can bring in one winner only.

To place 2-race Win/Exacta/Tricta bets, the bettor does first just as placing 1-race bets; then marks to select spots 23, 24, and/or 25. If one spot 25 is selected, then at least one spot 24 must be selected. If one spot 24 is selected, then at least one spot 23 must be selected. Every selection extends all bets placed in Race 1. If the bettor wants only specific Race 1 bets to be extended in specific ways instead of all possible, then it is necessary to use separate slips. In the case of only spots 23 being selected, every selected i′ in spot 23 will form Win-Win 13(i)23(i′) bets, Exacta-Win 13(i)14(j)23(i′) bets, and/or Tricta-Win 13(i)14(j)15(k)23(i′) bets. In the case of only spots 23 and 24 being selected, every selected racer i′ in spot 23 and selected racer j′ in spot 24 where i′≠j′ will form Win-Exacta 13(i)23(i′)24(j′) bets, Exacta-Exacta 13(i)14(j)23(i′)24(j′) bets, and/or Tricta-Exacta 13(i)14(j)15(k)23(i′)24(j′) bets. If the bettor wants only specific combinations of selected racer i′ with racer j′ instead of all possible, then it is necessary to use separate slips. In the case of spot 25 being selected, every selected racer i′ in spot 23 and selected racer j′ in spot 24 and selected racer k′ in spot 25 where i′≠j′≠k′≠i′ will form Win-Tricta 13(i)23(i′)24(j′)25(k′) bets, Exacta-Tricta 13(i)14(j)23(i′)24(j′)25(k′) bets, and/or Tricta-Tricta 13(i)14(j)15(k)23(i′)24(j′) 25(k′) bets. If the bettor wants only spectic combinations of selected racer i′ with racer j′ and racer k′ instead of all possible, then it is necessary to use separate slips. Regardless of bet type, let #Race1 and #Race2 denote the number of bets in Race 1 and Race 2 respectively. The total number of 2-Race bets is Race1*#Race2. All bets on a slip can bring in one winner only.

To place 3-race Win/Exacta/Tricta bets, the bettor does first just as placing 2-race bets; then marks to select spots 33, 34, and/or 35. If one spot 35 is selected, then at least one spot 34 must be selected. If one spot 34 is selected, then at least one spot 33 must be selected. Every selection ex-tends all bets placed in Races 1 and 2. If the bettor wants only specific Races 1 and 2 bets to be extended in specific ways instead of all possible, then it is necessary to use separate slips. In the case of only spot 33 being selected, every selected racer i″ in spot 33 will form Win-Win-Win 13(i)23(i′)33(i″) bets, Exacta-Win-Win 13(i)14(j)23(i′)33(i″) bets, Tricta-Win-Win 13(i)14(j) 15(k)23(i′)33(i″) bets, Win-Exacta-Win 13(i)23(i′)24(j′)33(i″) bets, Exacta-Exacta-Win 13(I) 14(j)23(i′)24(j′)33(i″) bets, Tricta-Exacta-Win 13(i)14(j)15(k)23(i′)24(j′)33(i″) bets, Win-Tricta-Win 13(i)23(i′)24(j′)25(k′)33(i″) bets, Exacta-Tricta-Win 13(i)14(j)23(i′)24(j′)25(k′)33(i″) bets, Tricta-Tricta-Win 13(i)14(j)15(k)23(i′)24(j′)25(k′)33(i″) bets. In the case of only spots 33 being selected, every selected racer i″ in spot 33 and racer j″ in spot 34 where i″≠j″ will form Win-Win-Exacta 13(i)23(i′)33(i″)34(j″) bets, Exacta-Win-Exacta 13(i)14(j)23(i′)33(i″)34(j″) bets, Tricta-Win-Exacta 13(i)14(j)15(k)23(i′)33(i″)34(j″) bets, Win-Exacta-Exacta 13(i)23(i′) 24(j′)33(i″)34(j″) bets, Exacta-Exacta-Exacta 13(i)14(j)23(i′)24(j′)33(i″)34(j″) bets, Tricta-Exacta-Exacta 13(i)14(j)15(k)23(i′)24(j′)33(i″)34(j″) bets, Win-Tricta-Exacta 13(i)23(i′)24(j′) 25(k′)33(i″)34(j″) bets, Exacta-Tricta-Exacta 13(i)14(j)23(i′)24(j′)25(k′)33(i″)34(j″) bets, Tricta-Tricta-Exacta 13(i)14(j)15(k)23(i′)24(i′)25(k′)33(i″)34(j″) bets. If the bettor wants only specific combinations of selected racer i″ with racer j″ instead of all possible, then it is necessary to use separate slips. In the case of spot 35 being selected, every selected racer i″ in spot 33 and racer j″ in spot 34 and racer k″ in spot 35 where i′≠j″≠k″≠i″ will form Win-Win-Tricta 13(i)23(i′)33(i″) 34(j″)35(k″) bets, Exacta-Win-Tricta 13(i)14(j)23(i′)33(i″)34(j″)35(k″) bets, Tricta-Win-Tricta 13(i)14(j)15(k)23(i′)33(i″)34(j″)35(k″) bets, Win-Exacta-Tricta 13(i)23(i′)24(j′)33(i″)34(j″) 35(k″) bets, Exacta-Exacta-Tricta 13(i)14(j)23(i′)24(j′)33(i″)34(j″)35(k″) bets, Tricta-Exacta-Tricta 13(i)14(j)15(k)23(i′)24(j′)33(i″)34(j″)35(k″) bets, Win-Tricta-Tricta 13(i)23(i′)24(j′) 25(k′)33(i″)34(j″)35(k″) bets, Exacta-Tricta-Tricta 13(i)14(j)23(i′)24(j′)25(k′)33(i″)34(j″)35(k″) bets, Tricta-Tricta-Tricta 13(i)14(j)15(k)23(i″)24(j′)25(k′)33(i″)34(j″)35(k″) bets. If the bettor wants only spectic combinations of selected racer i″ with racer j″ and racer k″ instead of all possible, then it is necessary to use separate slips. Regardless of bet type, let #Race1, #Race2 and #Race3 denote the number of bets in Race 1, Race 2 and Race 3 respectively. The total number of 3-Race bets is #Race1*#Race2*#Race3. All bets on a slip can bring in one winner only.

Every marked bet slip will be examined and approved by the computer in order to issue a bet ticket as shown in FIGS. 2A or 3A. The bet ticket shows per bet amount, total number of bets, total bet amounts and that Race 1 starts at Draw # so and so. All racer selections will be marked by “X”. No ‘3rd’ will be printed (see FIG. 3A) unless the bets are of type ‘Tricta’. Neither ‘2nd’ nor ‘3rd’ will be printed if the bets are of type ‘Win’.

Race 2 credit bet: The player marks to select ‘credit percentage’ and either ‘new’ slip or not. Using a new slip, the bettor places bets as explained above except that instead of ‘Amount per bet’ or ‘Total bet amount’ now ‘credit’ must be marked. The credit modified by selected percentage on the hanging bet ticket will be evenly applied to all bets on the new slip. The bettor will receive a regular bet ticket for the new slip and a revised bet ticket just as the original one except that there is a “X” on the selected ‘credit percentage’. Using no new slip, the bettor just marks selections. In the case of Win/Place/Show, any new selection is a credit bet, denoted 23′(i′), 24′(j′) and 25′(k′). In the case of Win/Exacta/Tricta, the type of bets has already been determined by the original bets. If the type is ‘Win’, every newly selected racer i′ in spot 23 is a credit 23″(i′) bet. If the type is ‘Exacta’, every originally as well as newly selected racer i′ in spot 23 and racer j′ i″ in spot 24 with i′≠j′ will be combined to form a 23′(i′)24′(j′) bet. A 23′(i′)24′(j′) bet which is not an original 23(i′)24(j′) bet is a credit 23″(i′)24″(j′) bet. Let #23′(i′)24′(j′) denote the number of all 23′(i′)24(j′) bets and #23(i′)24(j′) that of all 23(i′)24(j′) bets. Then #Race2(cr)=#23″(i′)24″(j′)=#23′(i′)24′(j′)−#23(i′)24(j′) is the number of all credit bets. If the type is ‘Tricta’, every originally as well as newly selected racer i″ in spot 33 and racer j″ in spot 34 and racer k″ in spot 35 with i′≠j′≠k′≠i′ will be combined to form a 23′(i′)24′(j′)25′(k′) bet. A 23′(i′)24′(j′)25′(k′) bet which is not an original 23(i′)24(j′)25(k′) bet is a credit 23″(i′)24″(j′)25″(k′) bet. Let #23′(i′)24′(j′) 25′(k′) denote the number of all 23′(i′)24(j′)25(k′) bets and #23(i′)24(j′)25(k′) that of all 23(i′)24(j′)25′(k′) bets. Then #Race2c=#23″(i′)24′(j′)25″(k′)#23′(i′)24′(j′)25′(k′)−#23(i′)24(j′)25(k′) is the number of all credit bets. The credit modified by selected percentage will be evenly applied to all credit bets.

Every hanging multi-race ticket used as Race 2 credit bet slip will be examined by the computer so that a revised ticket as shown in FIG. 3B can be issued. The revised ticket shows original data, selected credit percentage, and new selections marked with “=” The first three finishers of Race 1 will be printed in gray color. If credit bets are placed after the start of Race 2, there is another set of F indicating new finish lines valid as of bet entry. The revised ticket can be used as bet slip for Race 3 credit bets if it remains hanging.

Race 3 credit bet: The player marks to select ‘credit percentage’ and so on as stated above for Race 2 credit bets. In the case of Win/Place/Show, any new selection is a credit bet, denoted 33′(i″), 34″(j″) and 35′(k″). In the case of Win/Exacta/Tricta, the type of bets has already been determined by the original bets. If the type is ‘Win’, every newly selected racer i″ in spot 33 is a credit 33″(i″) bet. If the type is ‘Exacta’, every originally as well as newly selected racer i″ in spot 33 and racer j″ in spot 34 with i″≠j″ is a 33′(i″)34′(j″) bet. A 33′(i″)34′(j″) bet which is not an original 33(i″)34(j″) bet is a credit 33″(i″)34″(j″) bet. Let #33″(i″)34′(j″)denote the number of all 33′(i″)34′(j″) bets and #33(i″)34(j″) that of all 33(i″)34(j″) bets. Then #Race3(cr)#33″(i″)34″(j″)=#33′(i″)34′(j″)−#33(i″)34(j″) is the number of all credit bets. If the type is “Tricta”every originally as well as newly selected racer i″ in spot 33 and racer j″ in spot 34 and racer k″ in spot 35 with i″≠j″≠k″≠i″ is a 33′(i″)34′(j″)35′(k″) bet. A 33′(i″)34′(j″)35′(k″) bet which is not an original 33(i″)34(j″)35(k″) bet is a credit 33″(i″)34″(j″)35″(k″) bet. Let #33′(i″)34′(j″)35′(k″) be the number of all 33′(i″)34′(j″)35′(k″) bets and #33(i″)34(j″)35(k″) that of all 33(i″)34(j″)35(k″) bets. Then #Race2cr#33″(i″)34″(j″)35″(k″)=#33′(i″)34′(j″)35′(k″)−#33(i″)34(j″)35(k″) is the number of credit bets. The credit modified by selected percentage will be evenly applied to all credit bets. Every hanging multi-race ticket, used as Race 3 credit bet slip, will be examined by the computer so that a revised ticket as shown in FIGS. 2C or 3C can be issued. The revised tic-ket shows original data, selected credit percentage, and new selections marked with “=” The first three finishers of Race 2 will be printed in gray color. If credit bets are placed after the start of Race 3, there is another set of F indicating new finish lines valid as of bet entry.

### DESCRIPTION OF PLACING BETS AS IN U.S. Pat. No. 5,795,226

In U.S. Pat. No. 5,795,226, using the preferred embodiment, there are nine racers. Racers 1 to 3 have each 14 spaces to advance, racers 4 to 6 each 15 spaces, racers 7 to 9 each 16 spaces. There are nine races. The racer carrying the race number moves first. There are Regular betting ahead of a race, Second Chance betting after the first round of advancements, and Last Chance betting after the second round of advancements. To play the former Race i: The player sets up a race course using the former Racer i as Racer 1 with corresponding finish line, the former Racer i+1 as Racer 2 with corresponding finish line, and so on, after 9 comes 1, cyclically. On this slip the player places bets just as the former Regular ones with former Racer j being replaced by Racer j-i+1, cyclically. After Draw 1, the player sets up a second race course on a new slip using the former Racer i+l as new Racer 1 with corresponding finish line shortened as many spaces as already advanced, and the former Racer i+2 as new Racer 2 with corresponding finish line shortened as many spaces as already advanced, and so on, cyclically. On this second slip the player places bets as the former Second Chance ones with former Racer j being replaced by Racer j-i, cyclically. After Draw 2, the player sets up a third race course on a new slip using the former Racer i+2 as new Racer 1 with corresponding finish line shortened as many spaces as already advanced, and the former Racer i+3 as new Racer 2 with corresponding finish line shortened as many spaces as already advanced, and so on, cyclically. On this third slip the player places bets as the former Last Chance ones with former Racer j being replaced by Racer j-i−1, cyclically.

### Probability Formulae

Let g,h,i,j,k,l,m,n,s,u,x,y,z be natural numbers. We call the action of generating a random number from 1 to 6 ‘roll’.

A (n,s)-sequence is a sequence of n rolled numbers whose sum is s. For example, (2,5)-sequences are 1 4, 2 3, 3 2 or 4 1; (3,10)-sequences are 1 3 6, 1 4 5, 1 5 4, 1 6 3, 2 2 6, 2 3 5, 2 4 4, 2 5 3, 2 6 2, . . . 6 1 3, 6 2 2 or 6 3 1.

Let R(n,s) denote the total number of all possible (n,s)-sequences.

Obviously, R(1,1)=R(1,2)= . . . =R(1,6)=1 and R(1,s)=0 for s>6

In exactly 2 rolls we have s=2 by 1 1 only, and s=1 2 by 6 6 only; thus,
R(2,2)=R(2,12)=1

In exactly 2 rolls we have s=3 by 1 2 or 2 1, s=1 1 by 5 6 or 6 5, thus
R(2,3)=R(2,11)=2

In exactly 2 rolls we have s=4 by 1 3 or 2 2 or 3 1, s=1 0 by 4 6, 5 5 or 6 4 thus
R(2,4)=R(2,10)=3

Similarly we have
R(2,5)=R(2,9)=4
R(2,6)=R(2,8)=5
R(2,7)=6
R(2,0)=R(2,s)=0 for s>12

For n>2 we derive a recursion formula as follows:

Every (n,s)-sequence is a one-more-roll extension of a (n−1,k)-sequence where k is between s−6 and s−1. Thus,
R(n,s)=R(n−1,s−1)+R(n−1,s−2)+R(n−1,s−3)+ . . . +R(n−1,s−6)

Replacing s by s−1 we have
R(n,s−1)=R(n−1,s−2)+R(n−1,s−3)+R(n−1,s−4)+ . . . +R(n−1,s−7)

Together
R(n,s)=R(n,s−1)+R(n−1,s−1)−R(n−1,s−7), a recursion formula.

Note that R(n,s)=0 for s<n or 6n<s.

By the above formula we get all R(n,s) one by one as follows:
R(3,3)=0+R(2,2)−0=0+1 −0=1
R(3,4)=R(3,3)+R(2,3)−0=1+2−0=3
R(3,5)=R(3,4)+R(2,4)−0=3+3−0=6
R(3,10)=R(3,9)+R(2,9)−R(2,3)=25+4−2=27
R(3,18)=R(3,17)+R(2,17)−R(2,11)=3+0−2=1
R(4,4)=0+R(3,3)−0=0+1−0=1
R(4,5)=R(4,4)+R(3,4)−0=1+3−0=4
R(4,12)=R(4,11)+R(3,11)−R(3,5)=104+27−6=125
R(4,24)=R(4,23)+R(3,23)−R(3,17)=4+0−3=1
R(5,5)=0+R(4,4)−0=0+1−0=1
R(5,6)=R(5,5)+R(4,5)−0=1+4−0=5
etc.

A stand-by (n,s)-sequence is a sequence of n rolled numbers whose sum is between s−5 and s.

Examples: A stand-by (3,9)-sequence is x y z such that 4<=x+y+z<=9. It can be 1 1 2, 1 1 3, . . . , 1 1 6, 1 2 1, . . . , 1 2 6 , . . . , 1 6 2, . . . , 2 1 1, . . . , 2 6 1, . . . , 3 1 1, . . . , 3 5 1, 4 1 1, . . . , 4 4 1, 5 1 1 , . . . , 5 3 1, 6 1 1, 6 1 2, 6 2 1.

A winning (n,s)-sequence is a sequence of n rolled numbers whose sum is between s and s+5.

Examples: A winning (4,14)-sequence is x y z u such that 14<=x+y+z+u<=19. It can be 1 1 6 6, 1 2 5 6, 1 2 6 5, 1 2 6 6 , 1 3 4 6, . . . 1 3 6 6, 1 4 3 6, . . . 1 4 6 6, 1 5 2 6 . . . 1 5 6 6 . . . 1 6 1 6, . . . 1 6 6 6, 2 1 5 6, 2 6 5 6, 3 1 4 6, . . . 3 6 4 6, 4 1 3 6, . . . 4 6 3 4, 5 1 2 6, . . . , 5 6 2 6, 6 1 1 6, . . . 6 6 1 6.

Every roll extends a sequence. By a one-more-roll extension, all 6 stand-by (n−1,s−1)-sequences will result in a winning (n,s)-sequence; but only 5 stand-by (n−1,s−2)-sequences, 4 stand-by (n−1,s−3)-sequences, 3 stand-by (n−1,s−4)-sequences, 2 stand-by (n−1,s−5)-sequences, and just one stand-by (n−1,s−6)-sequence will result in winning (n,s)-sequences. Thus, the probability of any stand-by sequence to result in a winning (n,s)-sequence, denoted P(n,s), is 6*R(n−1,s−1)+5*R(n−1,s−2)+4* . . . +3* . . . +2* . . . +R(n−1,s−6) divided by 6*[R(n−1,s−1)+R(n−1,s−2)+ . . . + . . . + . . . +R(n−1,s−6)].

Consider now the case of playing alone, roll by roll, to get a winning (n,s)-sequence. Let ch(n,s) be the chance function stating your chance to enter the n-th roll. W(n,s)=ch(n,s)*P(n,s) will be the probability to win exactly in the n-th roll. Roll 1: ch(1,s)=1, W(1,s)=ch(1,s)*P(1,s). Roll 2: ch(2,s)=ch(1,s)−W(1,s), W(2,s)=ch(2,s)*P(2,s)=[ch(1,s)−W(1,s)]*P(2,s). Roll 3: ch(3,s)=ch(1,s)−W(1,s)−W(2,s), etc.

Example: The case of s=8.
Roll 1: ch(1,8)=1.
P(1,8)=0.
W(1,8)=ch(1,8)*P(1,8)=0.
Roll 2: ch(2,8)=ch(1,8)−W(1,8)=1.
P(2,8)=[6*R(1,7)+5*R(1,6)+4* . . . +3* . . . +2*R(1,3)+R(1,2)]/6*[R(1,7)+R(1,6)+ . . . +R(1,3)+R(1,2(]=15/6ˆ2.
W(2,8)=ch(2,8)*P(2,8)=15/6ˆ2.
Roll 3: ch(3,8)=ch(2,8)−W(2,8)=1−W(1,8)−W(2,8)=21/6ˆ2.
P(3,8)=[6*R(2,7)+5*R(2,6)+4* . . . +3* . . . +2*R(2,3)+R(2,2)]/6*[R(2,7)+R(2,6)+ . . . +R(2,3)+R(2,2)]=91/126.
W(3,8)=ch(3,8)*P(3,8)=91/6ˆ3.
Roll 4: ch(4,8)=ch(3,8)−W(3,8)=1−W(1,8)−W(2,8)−W(3,8)=35/6ˆ3
P(4,8)=[6*R(3,7)+5*R(3,6)+4* . . . +3* . . . +2*R(3,3)+R(3,2)]/6*[R(3,7)+R(3,6)+ . . . +R(3,3)+R(3,2)]=5/6.
W(4,8)=ch(4,8)*P(4,8)=175/6ˆ4.
Roll 5: ch(5,8)=ch(4,8)−W(4,8)=1−W(1,8)−W(2,8)− . . . −W(4,8)=35/6ˆ4.
P(5,8)=[6*R(4,7)+5*R(4,6)+4* . . . +3* . . . +2*R(4,3)+R(4,2)]/6*[R(4,7)+R(4,6)+ . . . +R(4,3)+R(4,2)]=9/10.
W(5,8)=ch(5,8)*P(5,8)=189/6ˆ5.
Roll 6: ch(6,8)=ch(5,8)−W(5,8)=1−W(1,8)−W(2,8)− . . . −W(5,8)=21/6ˆ5.
P(6,8)=[6*R(5,7)+5*R(5,6)+4* . . . +3* . . . +2*R(5,3)+R(5,2)]/6*[R(5,7)+R(5,6)+ . . . +R(5,3)+R(5,2)]=17/18.
W(6,8)=ch(6,8)*P(6,8)=119/6ˆ6.
Roll 7: ch(7,8)=ch(6,8)−W(6,8)=1−W(1,8)−W(2,8)− . . . −W(6,8)=7/6ˆ6.
P(7,8)=[6*R(6,7)+5*R(6,6)+4* . . .+3* . . .+2*R(6,3)+R(6,2)]/6*[R(6,7)+R(6,6)+ . . . +R(6,3)+R(6,2)]=41/42.
W(7,8)=ch(7,8)*P(7,8)=41/6ˆ7.
Roll 8: ch(8,8)=ch(7,8)−W(7,8)=1−W(1,8)−W(2,8)− . . . −W(7,8)=1/6ˆ7.
P(8,8)=[6*R(7,7)+5*R(7,6)+4* . . .+3* . . .+2*R(7,3)+R(7,2)]/6*[R(7,7)+R(7,6)+ . . . +R(7,3)+R(7,2)]=1.
W(8,8)=ch(8,8)*P(8,8)=1/6ˆ7.

Since ch(8,8)−W(8,8)=1−W(1,8)−W(2,8)− . . . −W(8,8)=0, no further roll can win.

Now our race game is that every Racer i is playing with competition to get a winning (n, Tr(i))-sequence where Tr(i) denotes the track length of Racer i, i.e., the number of advancement spaces from start to finish. There are P(n, Tr(i)) just as explained above. Let A(n,i) denote the probability of Racer i finishing Tr(i) first in competition in exactly n rolls.
A(n,i)=P(n,Tr(i))*ch(n,i)
where ch(n,i), the chance of reaching the n-th roll, is equal to [1-all A(n,i) listed ahead, if any] ordered as follows: The first n is 1 and the first i is 1. Let i run from 1 to 9, then increase n by one and run another cycle of i as before and so on till n=g with ch(n,i) being immaterial. We'll talk about some specific g later on.

The probability of Racer i finishing first is
W(i)=A(1,i)+A(2,i)+A(3,i)+ . . . +A(g,i)

Let Bm(n,i,j) denote the probability of Racer j finishing Tr(j) in competition in exactly n rolls after Racer i finishing first in exactly m rolls.
Bm(n,i,j)=P(n,Tr(i))*ch(n,i,j)
where ch(n,i,j), the chance of Racer j reaching the n-th roll, is equal to [1-all Bm(n,i,j) listed ahead, if any] ordered as follows: The first n is m and the first j is i+1 which is 1 if i=9. Let j run from i+1 to 9 and then from 1 to i−1, then increase n by one and run another cycle of j as before and so on till n=g.

Note that, writing computer program to calculate, one has to set Bm(n,i,j)=0 when it is so, namely
for i=j
for n=m and j<i

The probability of Racer i finishing first and Racer j second is

$$X ( i , j ) = \begin{matrix}\begin{matrix}\begin{matrix}A ( 1 , i ) * [ B 1 ( 1 , i , j ) + B 1 ( 2 , i , j ) + … + B 1 ( g , i , j ) ] + \\ A ( 2 , i ) * [ B 2 ( 2 , i , j ) + B 2 ( 3 , i , j ) + … + B 2 ( g , i , j ) ] +\end{matrix} \\ A ( 3 , i ) * [ B 3 ( 3 , i , j ) + B 3 ( 4 , i , j ) + … + B 3 ( g , i , j ) ] + … +\end{matrix} \\ A ( g , i ) * B g ( g , i , j )\end{matrix}$$

The probability of Racer j finishing first or second is
PB(j)=W(j)+X(1,j)+X(2,j)+X(3,j)+ . . . +X(9,j)

Let Cm(n,i,j,k) be the probability of Racer k finishing Tr(k) in competition in exactly n rolls after Racer i has finished first in m rolls or less and Racer j finishing second in exactly m rolls.
Cm(n,i,j,k)=P(n,Tr(i))*ch(n,i,j,k)
where ch(n,i,j,k), the chance of Racer k reaching the n-th roll, is equal to [1-all Cm(n,i,j,k) listed ahead, if any] ordered as follows: The first n is m and the first k is j+1 which is I if j=9 Let k run from j+1 to 9 and then from 1 to j−1, then increase n by one and run another cycle of k as before and so on till n=g.

Note that, writing computer program to calculate, one has to set Cm(n,i,j,k)=0 when it is so, namely

for i=j or i=k or j=k

for n=m and i<j and k<j

for n=m and j<i

for n=m and j=1
for n=m+1 and k<j<i
for n=m+1 and i=1 and k<j

The probability of Racers i, j, k finishing first, second and third respectively is

$$T ( i , j , k ) = A ( 1 , i ) * \{ B 1 ( 1 , i , j ) * [ C 1 ( 1 , i , j , k ) + C 1 ( 2 , i , j , k ) + … + C 1 ( g , i , j , k ) ] + B 1 ( 2 , i , j ) * [ C 2 ( 2 , i , j , k ) + C 2 ( 3 , i , j , k ) + … + C 2 ( g , i , j , k ) ] + B 1 ( 3 , i , j ) * [ C 3 ( 3 , i , j , k ) + C 3 ( 4 , i , j , k ) + … ] + … + B 1 ( g , i , j ) * C g ( g , i , j , k ) \} + A ( 2 , i ) * \{ B 2 ( 2 , i , j ) * [ C 2 ( 2 , i , j , k ) + C 2 ( 3 , i , j , k ) + … + C 2 ( g , i , j , k ) ] + B 2 ( 3 , i , j ) * [ C 3 ( 3 , i , j , k ) + C 3 ( 4 , i , j , k ) + … + C 3 ( g , i , j , k ) ] + B 2 ( 4 , i , j ) * [ C 4 ( 4 , i , j , k ) + C 4 ( 5 , i , j , k ) + … ] + … + B 2 ( g , i , j ) * C g ( g , i , j , k ) \} + A ( 3 , i ) * \{ B 3 ( 3 , i , j ) * [ C 3 ( 3 , i , j , k ) + … ] + … + B 3 … \} + A ( 4 , i ) * \{ B 4 ( 4 , i , j ) * … + … \} + … + A ( g , i ) * B g ( g , i , j ) * C g ( g , i , j , k )$$

The probability of Racer k finishing first, second or third is

$$S ( k ) = \begin{matrix}\begin{matrix}\begin{matrix}P ( k ) + T ( 1 , 1 , k ) + T ( 1 , 2 , k ) + T ( 1 , 3 , k ) + … + \\ T ( 1 , 9 , k ) + T ( 2 , 1 , k ) + T ( 2 , 2 , k ) + T ( 2 , 3 , k ) + … +\end{matrix} \\ T ( 2 , 9 , k ) + T ( 3 , 1 , k ) + … + … + … +\end{matrix} \\ T ( 9 , 8 , k ) + T ( 9 , 9 , k )\end{matrix}$$

Note that the QBasic program File 91416 in U.S. Pat. No. 5,795,226 can be adjusted by resetting Tr(i) and other parameter values to calculate any probabilities of the above formulae. P(n,1) in U.S. Pat. No. 5,795,226 was defined slightly different from P(n,s), but all numerical values P(n,1) in subroutine SUB calc2P are exactly P(n,s). Because the letter 1 is hardly distinguishable from the number 1, it has be replaced by s.

Let's turn to the problem of chance being immaterial under the following assumptions: 1. There are 9 racers. 2. Tr(i)<=16. 3. The race ends when three racers finish. Then ch(n,i), ch(n,i,j), and ch(n,i,j,k) are all immaterial for n>=g=7 for the following reason. The summation of R(7,7) to R(7,42) is 6ˆ7=279936. Those of value less than 16 are: R(7,7)=1, R(7,8)=7, R(7,9)=28, R(7,10)=84, R(7,11)=210, R(7,12)=462, R(7,13)=917, R(7,14)=1667, R(7,15)=2807. Their sum is 6183. Thus, after seven rolls the chance of a racer having moved less than 16 spaces is 6183/279936<1/40. The chance of a race still having finished after 7 rolls is less than (1/40)ˆ7 (the exponent 7 stands for racers not for rolls). This means, using g=7, the probability calculation error is less than one billionth. Using today's computer, one can neglect the ‘immaterial’ question, and let the calculation go on to g being equal to the maximal Tr(i).

### Payouts and Credits

The basic rule is that every $a bet with winning probability p pays $a/p. Every $a bet with probability p to become or remain hanging earns the credit of $a/p. Only-regular bets can earn credit to be applied evenly to all credit bets. Any Race 2 credit bet gets payout after Race 2.

Let $a be per bet amount, and r2 and r3 respectively the selected Race 2 and Race 3 credit percentages.

1-Race bet with winning probability p1 pays $a/p1.

2-Race bet with Race 1 winning probability p1 earns credit $a*#Race2/#Race2cr*p1 for each of #Race2cr bets, which makes a credit bet with winning probability p2 pay $a*#Race2*0.01*r2/(#Race2cr*p1*p2).

2-Race bet with Race 1 winning probability p1, Race 2 winning probability p2, pays $a*#0.01*(100−r2)/(p1*p2).

3-Race bet with Race 1 winning probability p1 earns credit $a*#Race2*#Race3/#Race2cr*p1 for each of #Race2cr credit bets, which makes a credit bet with winning probability p2 pay $a* #Race2*#Race3*0.01*(100−r2)/(#Race2cr*p1*p2).

3-Race bet with Race 1 winning probability p1, and Race 2 winning probability p2, earns credit $a*#Race3*0.01*(100−r2)/#Race3cr*p1*p2 for each of #Race3cr credit bets, which makes a credit bet with winning probability p3 pay $a*#Race3*0.01*(100−r2)*0.01*r3/(#Race3cr*p1*p2*p3).

3-Race bet with Race 1 winning probability p1, Race 2 winning probability p2, and Race 3 winning probability p3, pays $a*0.01*(100−r2)*0.01*(100−r3)/(p1*p2*p3).

### NUMERICAL EXAMPLES

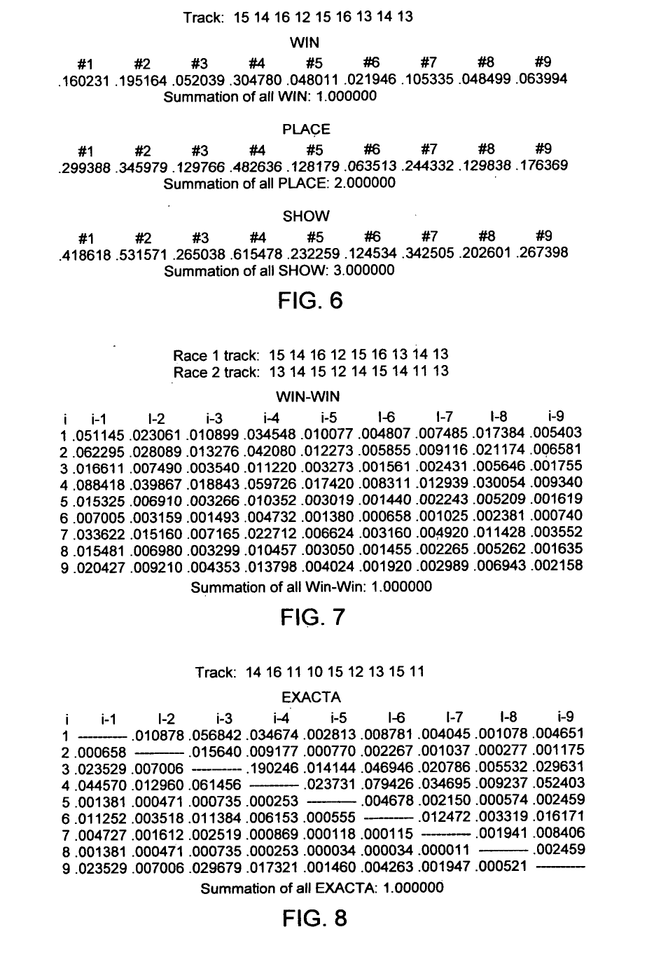

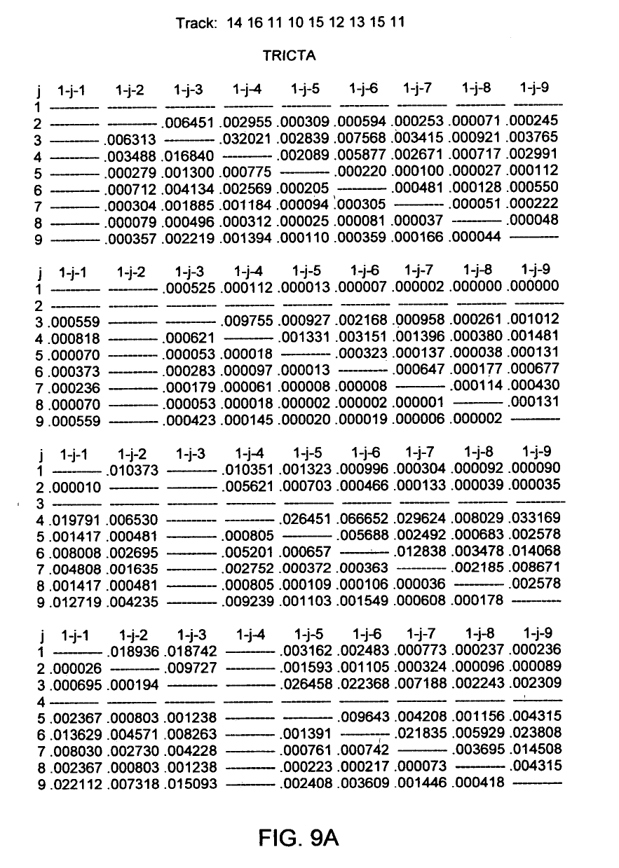

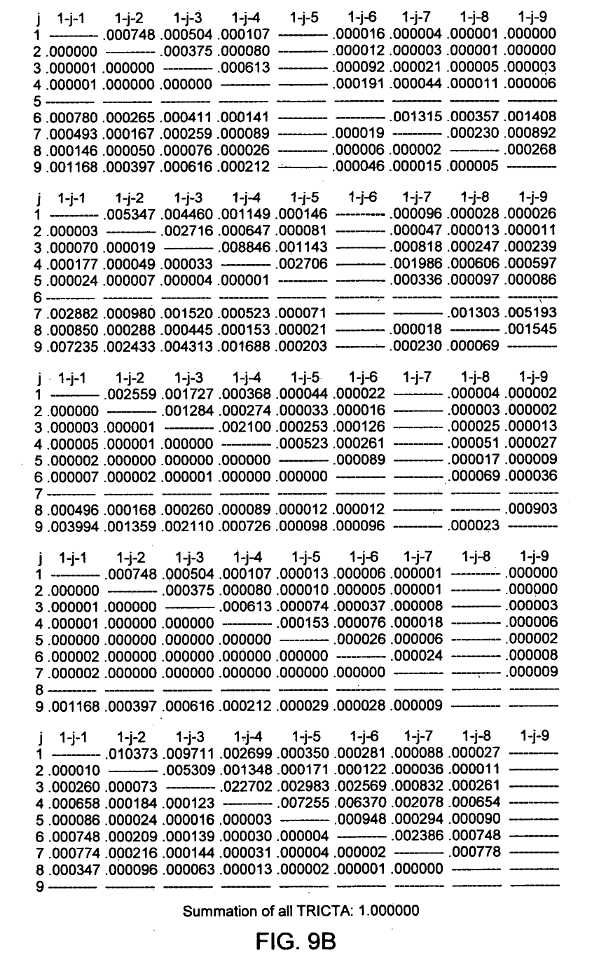

FIG. 6 shows all Win/Place/Show probabilities of Race 1 in FIG. 2A. FIG. 7 shows all Win-Win probabilities of Races 1 and 2 in FIG. 2A. FIG. 8 shows all Exacta probabilities of Race 1 in FIG. 3A. FIGS. 9A and 9B show all Tricta probabilities of Race 1 in FIG. 3A.

Let's turn to the ticket shown in FIG. 2C and assume that, in Race 3, racers 3, 8 and 6 finish the first, second and third respectively.

Here we have a=0.10, #Race2=6, #Race2cr=4, #Race3=6, #Race3cr=4, r2=50, r3=50, and the following winning probabilities for payout and credit calculation (For W(i), P(i), S(i), we use 1, 2, 3, 2cr, 3cr to indicate race number and credit race.):
Race 1: Wi(9)=0.063994, P1(9)=0.176369, P1(4)=0.482636, S1(2)=0.531571.
Race 2: P2(3)=0.063501. Race 2cr: W2cr(8)=0.211870, S2cr(5)=0.251220.
Race 3: S3(3)=0.362356. Race 3cr: P3cr(3)=0.527387, P3cr(8)=0.301041.

Thus, for each of four Race 2 23′(8), 23′(9), 25′(4), 25′(5) credit bets:
13(9) bet earns credit $a*#Race2*#Race3/(#Race2cr*W1(9))=$0.06.
14(9) bet earns credit $a*#Race2*#Race3/(#Race2cr*P1(9))=$0.16.
14(4) bet earns credit $a*#Race2*#Race3/(#Race2cr*P1(4))=$0.43.
15(2) bet earns credit $a*#Race2*#Race3/(#Race2cr*S1(2))=$0.48.
13(9)23′(8) credit bet pays $a*#Race2*#Race3*0.01*(100−r2)/(#Race2cr*W1(9)*W2cr(8))=$33.19.
14(9)23′(8) credit bet pays $a*#Race2*#Race3*0.01*(100−r2)/(#Race2cr*P1(9)*W2cr(8))=$12.04.
14(4)23′(8) credit bet pays $a*#Race2*#Race3*0.01*(100−r2)/(#Race2cr*P1(4)*W2cr(8))=$4.40.
15(2)23′(8) credit bet pays $a*#Race2*#Race3*0.01*(100−r2)/(#Race2cr*S1(2)*W2cr(8))=$4.00.
13(9)25′(5) credit bet pays $a*#Race2*#Race3*0.01*(100−r2)/(#Race2cr*W1(9)*S2cr(5))=$27.99.
14(9)25′(5) credit bet pays $a*#Race2*#Race3*0.01*(100−r2)/(#Race2cr*P1(9)*S2cr(5))=$10.16.
14(4)25′(5) credit bet pays $a*#Race2*#Race3*0.01*(100−r2)/(#Race2cr*P1(4)*S2cr(5))=$3.71.
15(2)25′(5) credit bet pays $a*#Race2*#Race3*0.01*(100−r2)/(#Race2cr*S1(2)*S1(2)*S2cr(5))=$3.37.

For each of four Race 3 33′(5), 33′(8), 34′(3), 34′(8) credit bets:
13(9)24(3) bet earns credit $a*#Race3*0.01*(100−r2)/(#Race3cr*W1(9)*P2(3))=$18.46.
14(9)24(3) bet earns credit $a*#Race3*0.01*(100−r2)/(#Race3cr*P1(9)*P2(3))=6.70.
14(4)24(3) bet earns credit $a*#Race3*0.01*(100−r2)/(#Race3cr*P1(4)*P2(3))=$2.45.
15(2)24(3) bet earns credit $a*#Race3*0.01*(100−r2)/(#Race3cr*S1(2)*P2(3))=$2.22
13(9)24(3)34′(3) credit bet pays $a*#Race3*0.01*(100−r2)*0.01*r3/(#Race3cr*W1(9)*P2(3)*P3cr(3))=$17.50.
14(9)24(3)34′(3) credit bet pays $a*#Race3*0.01*(100−r2)*0.01*r3/(#Race3cr*P1(9)*P2(3)*P3cr(3))=$6.35.
14(4)24(3)34′(3) credit bet pays $a*#Race3*0.01*(100−r2)*0.01*r3/(#Race3cr*P1(4)*P2(3)*P3cr(3))=$2.32.
15(2)24(3)34′(3) credit bet pays $a*#Race3*0.01*(100−r2)*0.01*r3/(#Race3cr*S1(2)*P2(3)*P3cr(3))=$2.11.
13(9)24(3)34′(8) credit bet pays $a*#Race3*0.01*(100−r2)*0.01*r3/(#Race3cr*W1(9)*P2(3)*P3cr(8))=$30.65.
14(9)24(3)34′(8) credit bet pays $a*#Race3*0.01*(100−r2)*0.01*r3/(#Race3cr*P1(9)*P2(3)*P3cr(8))=$11.12.
14(4)24(3)34′(8) credit bet pays $a*#Race3*0.01*(100−r2)*0.01*r3/(#Race3cr*P1(4)*P2(3)*P3cr(8))=$4.06.
15(2)24(3)34′(8) credit bet pays $a*#Race3*0.01*(100−r2)*0.01*r3/(#Race3cr*S1(2)*P2(3)*P3cr(8))=$3.69.
13(9)24(3)35(3) bet pays $a*0.01*(100−r2)*0.01*(100−r3)/(W1(9)*P2(3)*S3(3))=$16.98.
14(9)24(3)35(3) bet pays $a*0.01*(100−r2)*0.01*(100−r3)/(P1(9)*P2(3)*S3(3))=$6.16.
14(4)24(3)35(3) bet pays $a*0.01*(100−r2)*0.01*(100−r3)/(P1(4)*P2(3)*S3(3))=$2.25.
15(2)24(3)35(3) bet pays $a*0.01*(100−r2)*0.01*(100−r3)/(S1(2)*P2(3)*S3(3)=$2.04.

Next turn to the ticket shown in FIG. 3C and assume in Race 3 three sets of outcomes for the first three finishers: (1) Racers 6, 8 and 2. (2) Racers 9, 1 and 3. (3) Racers 4, 2 and 5. Here we have a=0.01, #Race2=28, #Race2cr=22, #Race3=36, #Race3cr=320, r2=50, r3=70, and the following winning probabilities for payout and credit calculation (For X(i,j), T(i,j,k), we use 1, 2, 3, 2cr, 3cr to indicate race number and credit race.):
Race 1: T1(6,1,7)=0.000096 Race 2: X2(3,2)=0.000734.
Race 3: T3(4,2,5)=0.002158, T3cr(6,8,2)=0.001062, T3cr(9,1,3)=0.005707.

Thus, for each of 22 Race 2 23″(i′)24″(j′)25″(k′) credit bets,
13(6)14(1)15(7) bet earns credit $a*#Race2*#Race3/(#Race2cr*T1(6,1,7))=$4,772.73

For each of 320 Race 3 33″(i″)34″(j″)35″(k″) credit bets:
13(6)14(1)15(7)23(3)24(2) bet earns credit $a*#Race3*0.01*(100−r2)/(#Race3cr*X2(3,2))=$0.77.

(1) 13(6)14(1)15(7)23(3)24(2)33″(6)34″(8)35″(2) credit bet pays
$a*#Race3*0.01*(100−r2)*0.01*r3/(#Race3cr*T1(6,1,7)*X2(3,2)*T3cr(6,8,2))=$5,261,731.50

(2) 13(6)14(1)15(7)23(3)24(2)33″(9)34″(1)35″(3) credit bet pays
$a*#Race3*0.01*(100−r2)*0.01*r3/(#Race3cr*T1(6,1,7)*X2(3,2)*T3cr(9,1,3))=$979,141.31.

(3) 13(6)14(1)15(7)23(3)24(2)33(4)34(2)35(5) bet pays
$a*0.01*(100−r2)*0.01*(100−r3)/(T1(6,1,7)*X2(3,2)*T3(4,2,5))=$9,864,441.00

Besides, consider for example, that in Race 2, Racer 6 instead of Racer 2 finishes second. Here we have X2cr(3,6)=0.020577, and 13(6)14(1)15(7)23″(3)24″(6) credit bet pays $a*#Race2*#Race3*0.01*(100−r2)/(#Race2cr*T1(6,1,7)*X2cr(3,6))=$115,972.37.

### Description of the Non-Automatic Game

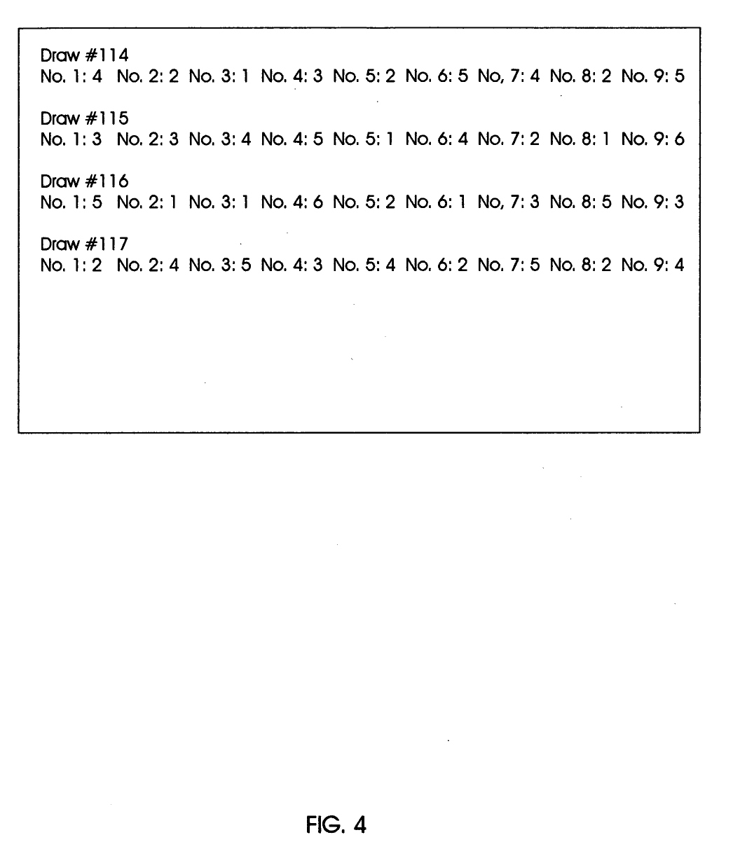

On bet slips as shown in FIGS. 2 or 3, players set up individual race courses and place bets. Bet slips will be approved by wagering machines to issue bet tickets. The operator starts to generate the first round of random numbers, called Draw #1, one number for each racer to advance accor dingly. The random numbers will be displayed on the monitor as shown in FIG. 4 and input into the computer to determine if any bet ticket earns payout or credit. Each player can mark on the bet ticket for each racer the advancement or another F indicating new finish line. Although the advancement of each racer in every race course will be updated in the computer system, every player must self check own racing progress. But there can be an optional feature allowing a bet ticket to be entered into the wagering machine in exchange for a ticket showing updated finish lines resulted from advancements.

Next, anyone, whether having placed bets before Draw #1 or not, can place bets just like before Draw #1. Besides, if a race has ended or resulted in a hanging ticket, its holder can eventually cash a payout or place free credit bets.—Draw #1 probably won't end any race.—The operator pays no attention to the progress of any race. After a preset period of time the operator generates the next round of random numbers, called Draw #2, for all racers. The outcomes will be displayed and data processed just like after Draw #1. Every player self checks own racing progress and takes further betting actions.

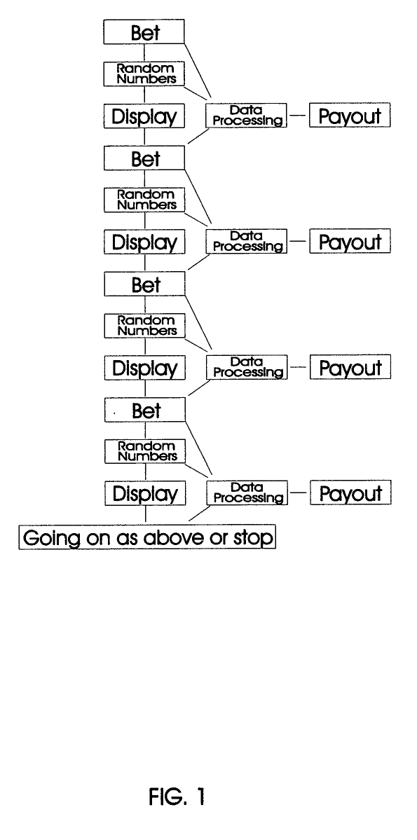

As the flowchart in FIG. 1 shows, more rounds of betting, random numbers, display, data processing and payout will follow. Unless pause or stop has been regulated ahead, the operator will let it go on indefinitely, while any player may start or stop betting anytime. The Draw # will grow accordingly. But players don't need to pay any attention to it. For the sake of reference, ‘Race 1 starts at Draw # so and so’ will be printed on every bet ticket. Any regulated stop of the game must allow every started race to finish.

### Description of the Automatic Version

To play the automatic game one needs either a video game machine or a personal computer equipped with made-to-order software inclusive a random number generator. The computer is connected to a pointing device or touch screen monitor so that the action ‘select’ below can be executed by means of the pointing device or finger touching. Selecting any icon/item on the display screen will either highlight it or result in a new display. Selecting a highlighted item is to cancel that selection. All figures printed on paper are supposed to be black, white and gray. Now, on monitor they can be quite colorful.

The game starts with the display of a bet slip as shown in FIGS. 2 or 3 with additional icons/items named “Alternative slip”, “Ticket”, and “Account”.

Selecting “Alternative slip” will switch to a Win/Exacta/Tricta bet slip screen if the displayed one is Win/Place/Show, or conversely.

The player places bets on screen just as in the non-automatic game. Then selects “Ticket” to submit. If the submitted slip is incomplete or contains error, there will be a message like ‘Incomplete! Please select per bet amount.’, requiring the player to make amendment. If the submission is approved, a bet ticket as shown in FIGS. 2A or 3A with no ticket number, but additional icons “Go back”, “Ticket#”, “Cancel”, “Bet slip”, “Run”, “Account” shows up.

Facing a bet ticket the player must select “Ticket#”, “Go back” or “Cancel”. Otherwise, there will be a message to remind the player to do so. Selecting “Ticket #” finalizes the bet so that a ticket number will be issued and shown on the ticket. Selecting “Go back” allows the player make changes on the submitted bet slip. Selecting “Cancel” is to abandon the submission.

After ‘Ticket # so and so’ or ‘Cancelled’ being displayed, the player can select “Bet slip”, “Run”, or “Account”.

Selecting “Bet slip” will display a blank one to take bet.

Selecting “Run” will cause one round of random numbers being generated. Consequently, the computer will update and process all bet ticket data accordingly. On every existing bet ticket there will be an additional F in front of every racer to indicate the closer finish line due to the advancement according to the random number.

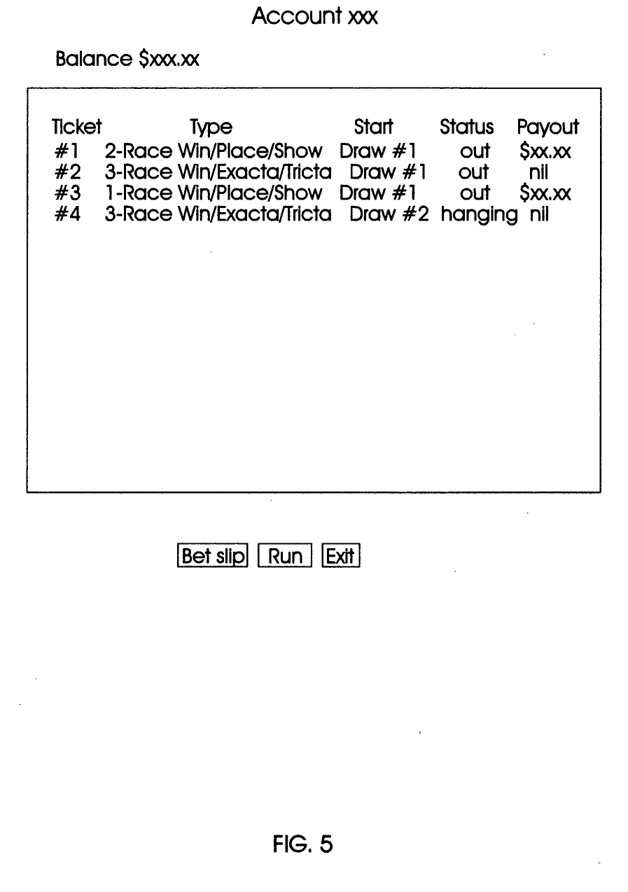

Selecting “Account’ will result in a display as shown in FIG. 5. It shows the available balance, and all betting activities since the start of the game or the opening of that account.

Here the player can select “Ticket # so and so” to view that ticket as well as to use it for placing credit bets just as in the non-automatic game.

“Bet slip” and “Run” allow the player to continue in whichever way preferred, while “Exit” to end the game.

### Conclusion

The preferred embodiment described above provides an extremely low operation cost game to be easily run by an existing or future keno/lottery kind of operator. Its automatic version can be easily integrated into some existing casino multi-game video machines.

As explained, the method presented here allows us to place bets just as in U.S. Pat. No. 5,795,226. What missing there, but available here are: 1. There is no need to display a race course with racing action for all players. 2. Anyone can start an own race anytime. 3. Each player can set up a race course with own preferred finish lines. 4. There is no fixed race number for all players, which is a kind of restraint in placing make-up bets. 5. Credit to place free make-up bets. Placing make-up bet within a race as in U.S. Pat. No. 5,795,226 will be a chief attraction to sophisticated players, even though for which there is no credit, and setting up additional bet slips is required.

To make the bettor without regret, every hanging bet receives credit equal to the payout of a bet which is up to that point equivalent to the hanging one, and just ends there. The operator can make house edge effective at the final payout. Charging house edge only on final payout makes purchasing a multi race ticket more incentive than purchasing tickets race by race. Besides, it should further be based on the ratio of payout to total bet amount so that lower ratio tickets enjoy lower house edges.

Here is a game operative under one management with both house bankroll and pari-mutuel jackpot. The operator may rule that a bet of certain huge payout with tiny winning probability is a jackpot bet, or that the bettor can choose whether to be a jackpot participant or not. For all non-jackpot wagering, printed precise house edge formulas must be available all the times. Naturally, setting house edges is not inventor's business, but I would like to give a sample set for reference:

Let x be the ratio of payout to total bet amount, and e% be house edge. e=x for 0<x<=5,
e=4.5+(x−5)/10 for 5<x<=10,
e=4+n(n+1)/2+(n+1)*(x−10ˆn)/9 for 10ˆn<x<=10ˆ(n+1) where n is a non-zero natural number.

Every ticket of total bet amount $b>$10 gets an F% discount on e, where f=4*log(b−10), and the logarithm base is 10. Thus, the actual payout is $b*(100−e*(100−4*log(b−10))%)% unless there is a minimal service charge.

Following the step by step derivation of probability formulae one can easily set up games similar to the one precisely described above. First, rolled numbers are not necessarily 1 to 6, it can be 0 to 5 or any other positive or negative integers where negative ones mean backward motion. Second, a roll is not necessarily to generate six numbers, it can be more or less. One can similarly define (n,s)-sequences, R(n,s), stand-by and winning sequences, and P(n,s) etc. Third, since Tr(i) is a variable, the maximal track length is not necessarily equal to 16. Fourth, the number of racers is not necessarily 9. If it is q instead of 9, then in A(n,i)=P(n,Tr(i))*ch(n,i) we let i goes from 1 to q instead of 1 to 9; —everywhere modulo 9 becomes modulo q—. One can similarly form Bm(n,i,j) and Cm(n,i,j,k) to calculate all kinds of probabilities for racers i, j, k finishing first, second and third. Besides, in the same art of forming Cm(n,i,j,k), one can form Dm(n,i,j,k,l), Em(n,i,j,k,l,h) etc. to calculate the probability of a racer finishing 4th, 5th, etc. so that betting can be more exotic than Tricta. And, multi races can be 4-race, 5-race, etc.

The rule that only regular bets earn credit can be changed so that, for example, the bettor may choose whether credit bets also earn credit instead of payout.

Thus, the scope of the invention should be determined by the appended claims and their legal equivalents, rather than by examples given.

I claim:

1. A method of playing a betting race game comprising the steps of
providing a plurality of bet slips,
said bet slip containing a race course,
providing a plurality of racers on the race course,
permitting players to set one finish line for each said racer,
permitting players to bet on the racers of the race before the start and among every round of advancement,
determining a plurality of numbers,
advancing the racers on the race course according to said plurality of numbers,
determining payout of every bet based on probability.

2. A method of playing a game using the steps of claim 1 and further comprising the steps of
providing calculation of credit for a hanging bet based on probability,
permitting the hanging bet holder to use own selected percentages of the credit to place free bets.

3. A method of playing a game of chance using the steps of claim 1 and further by means of a video game machine or personal computer.

4. A method of playing a game of chance using the steps of claim 2 and further by means of a video game machine or personal computer.
